(19) United States
(12) Patent Application Publication
(10) Pub. No.: US 2022/0257461 A1
(43) Pub. Date: Aug. 18, 2022

(54) Vibroacoustic Therapy Bed with Stowable Form Factor

(71) Applicant: Opus Immersive, Inc., Austin, TX (US)

(72) Inventors: Adam Schlender, Austin, TX (US); Christopher Schenk, Austin, TX (US); Yves Albert Behar, San Francisco, CA (US); Qin Li, San Francisco, CA (US); Daniel Charles Zarem, Los Altos Hills, CA (US); Jaehoon Jung, San Francisco, CA (US); Paolo Salvagione, Sausalito, CA (US)

(21) Appl. No.: 17/669,754

(22) Filed: Feb. 11, 2022

Related U.S. Application Data
(60) Provisional application No. 63/149,202, filed on Feb. 12, 2021.

(51) Int. Cl. A61H 23/02; A61G 7/008

(52) U.S. Cl. CPC A61H 23/02; A61G 7/008; A61H 2201/5061; A61H 2201/0188; A61H 2201/0142

(57) ABSTRACT

A vibroacoustic therapy bed delivers a sensory experience using integrated vibrational transducers, sounds, lighting effects, and/or other sensory elements. The vibroacoustic therapy bed includes a series of interconnected base elements and a pad. The vibroacoustic therapy bed is configurable between a flat configuration in which the base elements support a user laying on the pad and a stowable configuration in which the base elements pivot with respect to each other utilizing hinge connectors to form a compact structure suitable for stowing. The base elements may furthermore include an isolation element for attenuating transfer of vibrational energy from the vibrational transducers to the ground.

### CROSS-REFERENCE TO RELATED APPLICATIONS

This application claims the benefit of U.S. Provisional Application No. 63/149,202 filed on Feb. 12, 2021, which is incorporated by reference herein.

### BACKGROUND

### Technical Field

This application relates generally to a vibroacoustic therapy bed, and more specifically, to a vibroacoustic therapy bed with a stowable form factor.

### Description of Related Art

A vibroacoustic therapy bed includes a set of transducers that transfer vibrations to the body according to a programmed pattern. These vibration effects can provide health benefits such as increasing circulation, relieving pain, and improving mood. However, conventional vibroacoustic therapy beds are bulky, expensive, and impractical for many in-home environments or other limited spaces.

### BRIEF DESCRIPTION OF THE DRAWINGS

FIG. 1A is first view of an example embodiment of a vibroacoustic therapy bed in a flat configuration.

FIG. 1B is second view of an example embodiment of a vibroacoustic therapy bed in the flat configuration.

FIG. 2A is first view of an example embodiment of a vibroacoustic therapy bed in a stowable configuration.

FIG. 2B is second view of an example embodiment of a vibroacoustic therapy bed in the stowable configuration.

FIG. 3 is an example embodiment of a vibroacoustic therapy bed and associated stowable accessories.

FIG. 4A is first view of an example embodiment of a segment of a vibroacoustic therapy bed in a flat configuration.

FIG. 4B is second view of an example embodiment of a segment of a vibroacoustic therapy bed in a stowable configuration.

FIG. 5A is an example embodiment of a base element for a vibroacoustic therapy bed.

FIG. 5B is an example embodiment of the base element with a top plate detached.

FIG. 6 is an example embodiment of a top plate of a base element for a vibroacoustic therapy bed with integrated vibrational transducers.

FIG. 7A is an example embodiment of an isolation element associated with an active top plate of a vibroacoustic therapy bed.

FIG. 7B is an exploded view of an example embodiment of an isolation element associated with an active top plate of a vibroacoustic therapy bed.

FIG. 8A is an example embodiment of a pair of coupled base elements of a vibroacoustic therapy bed.

FIG. 8B is a zoomed view of a hinge connector for connecting a pair of base elements of a vibroacoustic therapy bed.

FIG. 8C is an exploded view of a hinge connector for connecting a pair of base elements of a vibroacoustic therapy bed.

FIG. 9 is an example embodiment of a base element for a vibroacoustic therapy bed with a hinging top plate.

FIG. 10A is a first view of an example embodiment of a base element for a vibroacoustic therapy bed with an integrated lighting system.

FIG. 10B is a second view of an example embodiment of a base element for a vibroacoustic therapy bed with an integrated lighting system.

FIG. 10C is a third view of an example embodiment of a base element for a vibroacoustic therapy bed with an integrated lighting system.

FIG. 11A is a first view of an example embodiment of a pair of base elements for a vibroacoustic therapy bed with an integrated lighting system.

FIG. 11B is a second view of an example embodiment of a pair of base elements for a vibroacoustic therapy bed with an integrated lighting system.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

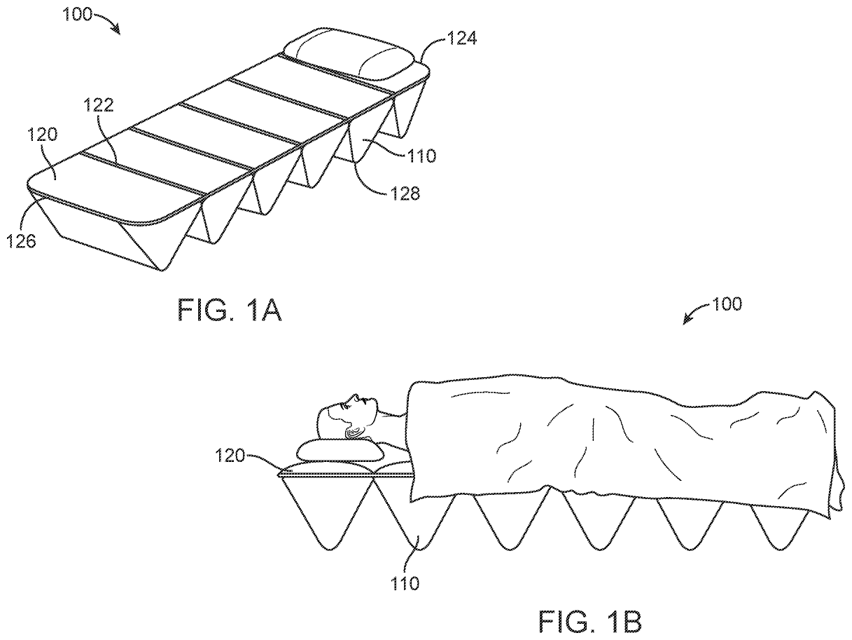

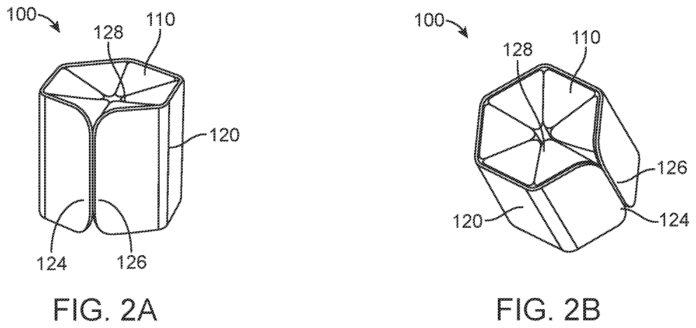

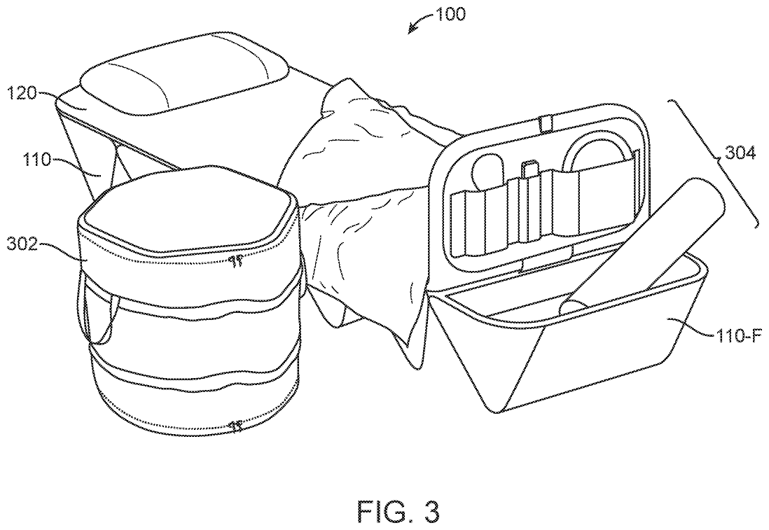

FIGS. 1A-2B illustrate an example of a vibroacoustic therapy bed 100. The vibroacoustic therapy bed 100 includes a series of interconnected base elements 110 and a pad 120. The vibroacoustic therapy bed 100 is configurable between a flat configuration of FIGS. 1A-1B and a stowable configuration of FIGS. 2A-2B. In the flat configuration, the base elements 110 provide a substantially flat upper surface that supports the pad 120 and enables a user to lay on top of the pad 120 (e.g., FIG. 1B). In operation, the vibroacoustic therapy bed 100 delivers vibrations, sounds, lighting patterns, and/or other sensory effects based on an encoded experience file or streaming content. Vibrations are delivered to various parts of the body using one or more acoustic transducers integrated into the base elements 110 as described below. The transducers may be positioned to align with the human body Chakra system in order to deliver high powered vibrational effects. The base elements 110 may also optionally deliver lighting effects via integrated lighting elements and/or deliver sounds directly through integrated speakers or indirectly through headphones worn by the user. Other embodiments may include different or additional sensory elements such as heaters, coolers, and scent diffusers. Control logic and/or software control actuating of these sensory elements according to a pre-programmed or live synchronized fashion. The vibroacoustic therapy bed 100 furthermore may include sensors to implement a local feedback loop fed by biometric devices, pressure sensors and other local sensor types integrated with the base elements 110. Vibrational isolation elements in the base elements 110 attenuate vibrational energy transferred to the ground and cause the energy to be focused on the user's body.

In the stowable configuration (FIGS. 2A-2B), the base elements 110 and pad 120 are rolled up into a compact form factor that can easily be stowed or may optionally be utilized as a chair. Hinge mechanisms integrated into the base elements 110 enable simple transition between the flat configuration and stowable configuration as described in further detail below.

In an embodiment, the base elements 110 each have a form factor substantially conforming to a triangular prism. In the flat configuration, lower vertex edges 128 of the triangular prisms rest on the ground while the faces opposite the ground vertex edge 128 collectively form a flat upper surface for supporting the pad 120. In the stowable configuration, adjacent base elements pivot about the pivot lines 122 between the adjacent base elements 110 to rotate the vertex edges 128 towards each other. The pad 120 similarly includes creases aligned with the pivot lines 122 to enable the pad 120 to fold along with the base elements 110. In the stowable configuration, the ground vertex edges 128 of the base elements 110 come near contact with each other along a central axis through the resulting structure, while the opposite faces (that support the pad 120 in the flat configuration) form an outer surface covered by the pad 120. The head end 124 and foot end 126 of the set of base elements 110 and pad 120 come in contact or near contact in the stowable configuration. Optionally, an integrated latch or strap at the head end 124 and/or foot end 126 of the vibroacoustic therapy bed 100 may be employed to secure the vibroacoustic therapy bed 100 in its stowable configuration.

In an embodiment, the vibroacoustic therapy bed 100 includes a set of six base elements 110 connected in a chain. The base elements 110 form a substantially rectangular top plate for supporting the pad 120 in the flat configuration and roll into a form factor substantially conforming to a hexagonal prism in the stowable configuration. In other embodiments, the vibroacoustic therapy bed 100 may have a different number of base elements 110. For example, a vibroacoustic therapy bed 100 may have n base elements 110 that roll into an n-sided polygonal prism in the stowable configuration, where n is an integer>1.

In an embodiment, the pad 120 comprises three layers including a resonant layer at the bottom, a cushion material in the middle, and a cover layer at the top. The bottom resonant layer of the pad 120 may be made of a honeycomb aluminum material and have a human form fitting geometry designed to transfer energy from the transducers integrated into the base elements 110. The middle cushion layer is made of a jelly rubber material and designed to form fit to the human back. This cushion layer may furthermore be designed to minimize the number of pressure peaks and their severity. The particular material characteristics may be selected to balance the transducer energy transference with comfort. The top layer may comprise a foamite or other material suitable for high volume clinical applications.

The vibroacoustic therapy bed further includes a set of power and signal cables that are manufactured in a thin flat ribbon cable design that can connect between the base elements 110. The power and signal cables may include quick disconnects to enable the base elements 110 to be disconnected from each other and optionally changed out for the purposes of maintenance or upgrades.

FIG. 3 illustrate the vibroacoustic therapy bed 100 together with a set of accessories 304. In the illustrated embodiment, one or more of the base elements 110-F has a hinged top plate that exposes a storage compartment for the accessories 304 when opened. The interior or top plate may include built-in pockets. The storage compartment may be used to store accessories 304 such as a weighted blanket, headphones, a blackout eye mask, power supply and cables, phone or tablet holder attachment, LED light therapy goggles, VR/AR headset, essential oils and diffuser attachment, etc. FIG. 3 also illustrates a storage bag 302 that can be used to store the vibroacoustic therapy bed 100 in the stowable configuration.

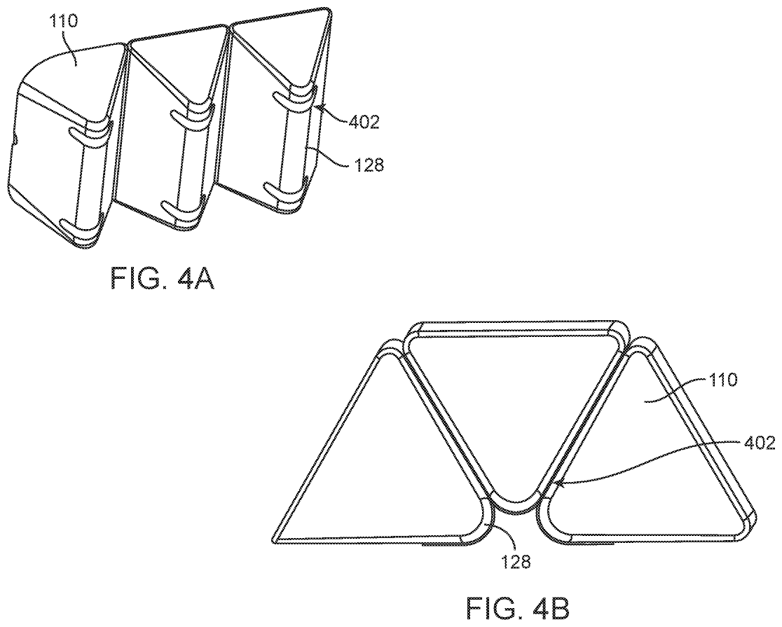

FIGS. 4A-4B illustrate a sub-section of the vibroacoustic therapy bed 100 (e.g., three base elements 110) in the flat configuration (FIG. 4A) and the stowable configuration (FIG. 4B). In this view, a set of pads 402 are positioned on the ground vertex edges 128 (near the triangular end faces) that make contact with the floor in the flat configuration. These pads 402 may operate to dampen vibrations and sound translated from the base elements 110 to the floor when the bed is in the flat configuration (FIG. 4A). When in the stowable configuration (FIG. 4B), the pads 402 may operate to protect the contacting surfaces of the base elements 110 from rubbing against each other.

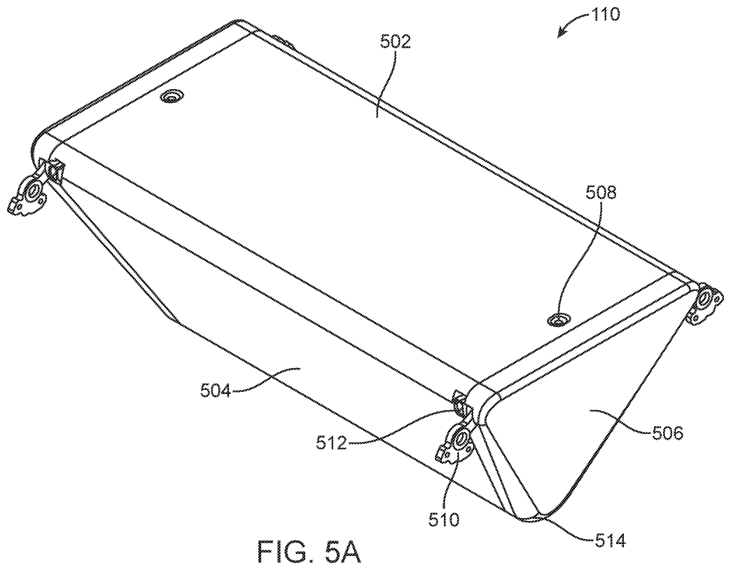

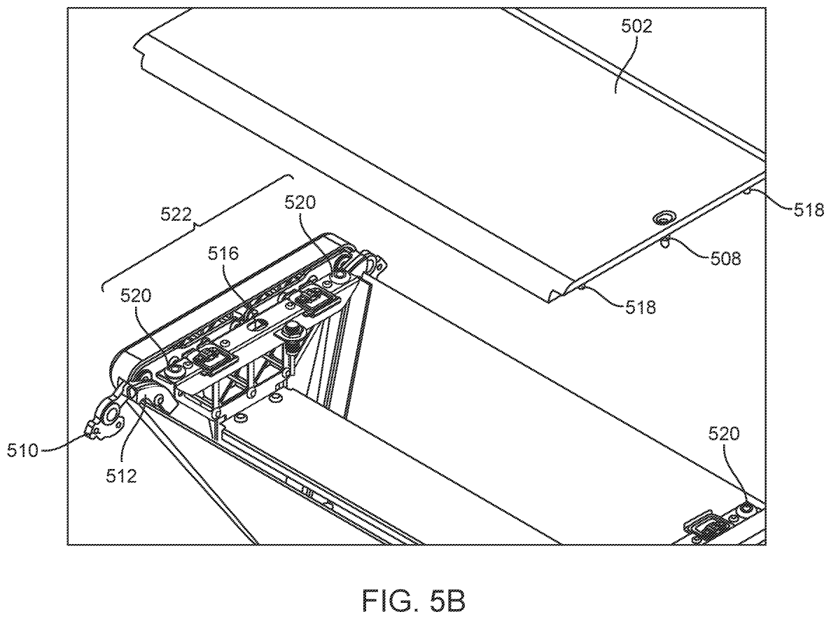

FIGS. 5A-5B illustrate an example embodiment of an individual base element 110 in more detail. Specifically, FIG. 5A illustrates a closed configuration and FIG. 5B illustrates an open configuration with a top plate 502 removed. The base element 110 is structured substantially as an inverted triangular prism with two substantially triangular side faces 506 and three substantially trapezoidal (e.g., rectangular) faces 502, 504. A ground vertex edge 514 rests on the ground in the flat configuration and a top plate 502 opposite the ground vertex edge 514 supports the pad 120. Hinge connectors 510 protrude from the corners of the top plate 502 to couple with adjacent base elements 110 as will be further described below. The base elements 110 furthermore include cable passthroughs 512 adjacent to the hinge connectors 510 to enable power and communication cables to pass between adjacent base elements 110 for powering the acoustic transducers and other integrated electronics.

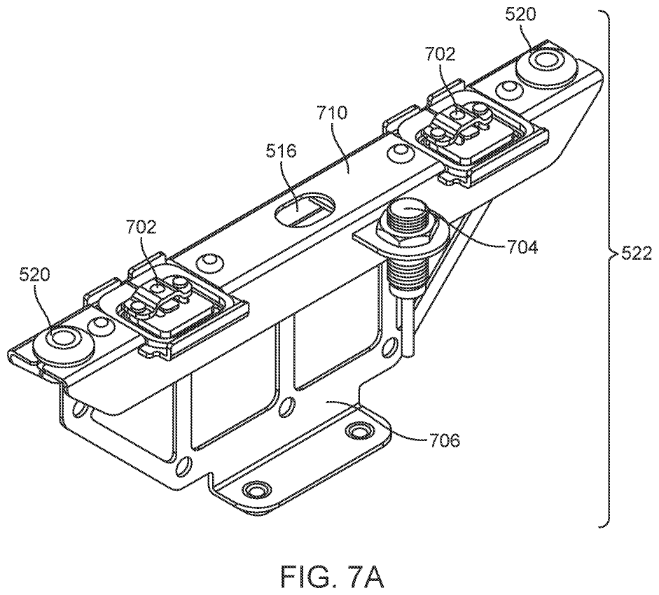

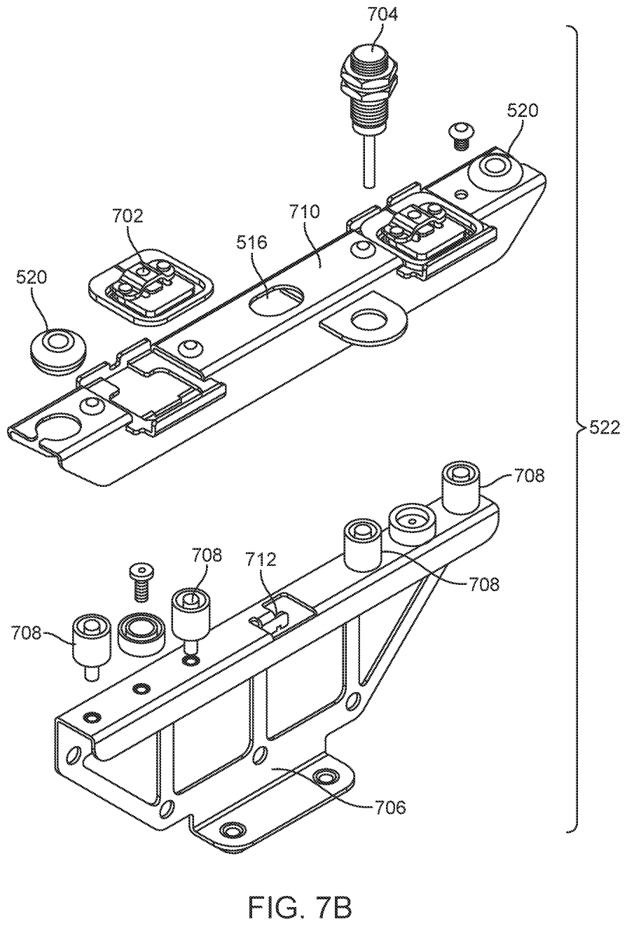

As visible in FIG. 5B, an isolation element 522 is securely mounted on the interior sides (adjacent to the triangular faces 506) of each base element 110. The isolation element 522 operates to attenuate transfer of vibrations from transducers integrated in the top plate 502 to the ground. The isolation element 522 also includes coupling components 520, 516 that interface with reciprocal coupling components 518, 508 to secure the top plate 502 to the isolation element 522. In one embodiment, the top plate 502 includes a set of dowels 518 that mate with a pair of grommets 520 (e.g., rubber grommets) when the top plate 502 is secured to the isolation element 522, thus ensuring proper alignment of the top plate 502. Furthermore, a spring assembly 508 passes through the hole 518 in the isolation element 522 and couples to a clip (not visible in FIG. 5B, illustrated in FIG. 7C).

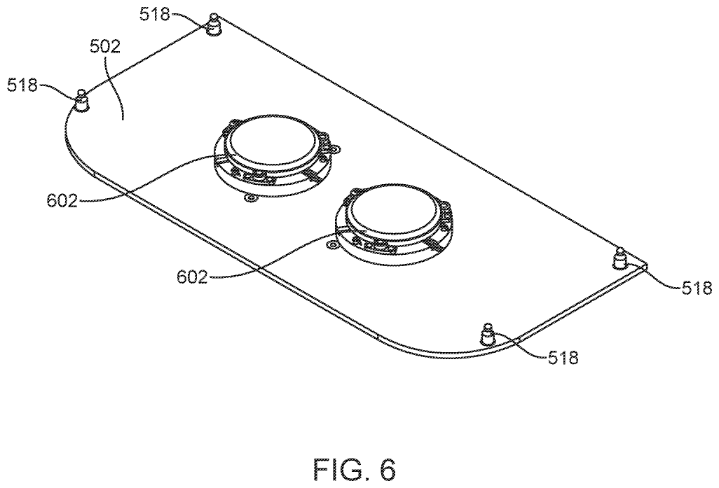

FIG. 6 illustrates an example embodiment of the underside of the top plate 502 (flipped over relative to FIG. 5B). The top plate 502 includes the dowels 518 described above and one more integrated transducers 602. FIG. 6 illustrates an embodiment with two transducers 602. In other embodiments, the top plate 502 may include only a single transducer 602 or may include more than two transducers. The top plate 502 may furthermore include electronic components such as integrated amps, wires and power supplies, a control board with data storage and digital signal processor, external USB and aux in and out ports, and programmable LED lighting supporting delivery of the effects described herein. In other alternative embodiments, one or more of those components may be integrated elsewhere in the base element 110 and not necessarily in the top plate 502.

FIG. 7A-7B illustrate an example embodiment of the isolation element 522 in further detail. Specifically, FIG. 7A illustrates an isolation element 522 removed from the base element 110 and FIG. 7B illustrates an exploded view of the isolation element 522. The isolation element 522 includes a frame 706, 710 (e.g., metal or plastic) comprising the grommets 520 (described above), the hole 516 (described above), and a set of sensors including one or more load sensors 702 and one or more presence sensors 704. As seen in the exploded view (FIG. 7B), the frame an upper frame 710, a lower frame 706, a set of elastic spacers 708 between the upper frame 710 and the lower frame 706, and the clip 712 described above for securing the spring assembly 508 of the top plate 502. The presence sensor 704 senses when the top plate 502 is secured to the remaining portion of the base element 110. The presence sensor 704 may operate as a safety mechanism to turn off power to the electronics when the presence sensor 704 detects removal of the top plate 502. The presence sensor 704 may comprise, for example, a hall effect sensor. The load sensor 702 senses a force applied to it and may be utilized to estimate the weight of an individual laying on the vibroacoustic therapy bed 100. The spring assembly 508 described above operates in conjunction with the load sensors 702 to secure the top plate 502 to the isolation element 522 while still allowing some vertical movement of the top plate 502 in response to an applied force to enable the load sensors 702 to deflect and sense the applied force. The elastic spacers 708 are secured between the lower frame 706 and the upper frame 710 and operate to attenuate transfer of vibrations from the upper frame 710 to the lower frame 706 (and subsequently to the ground).

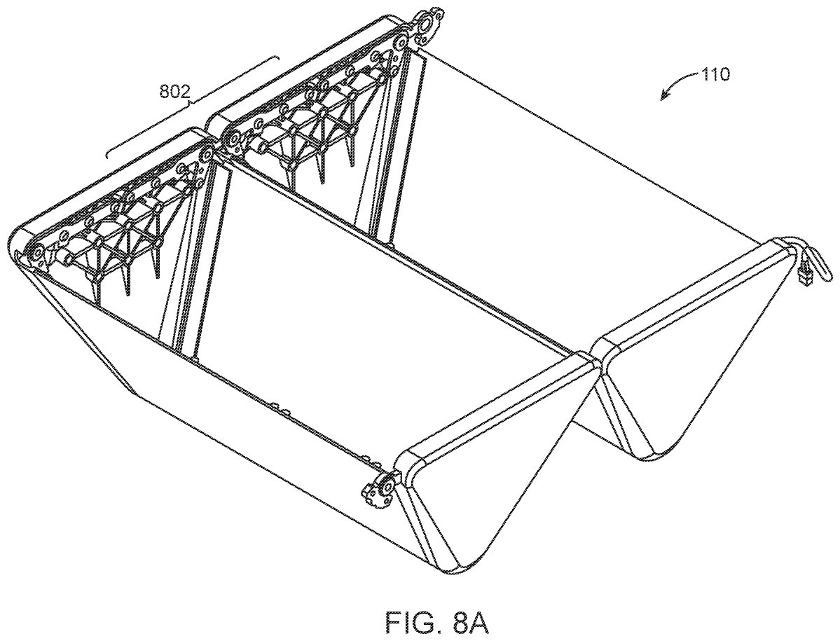

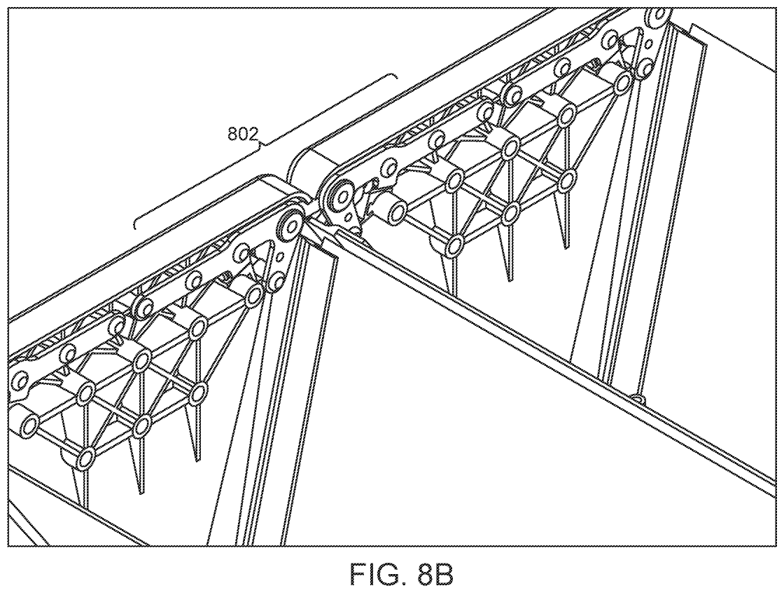

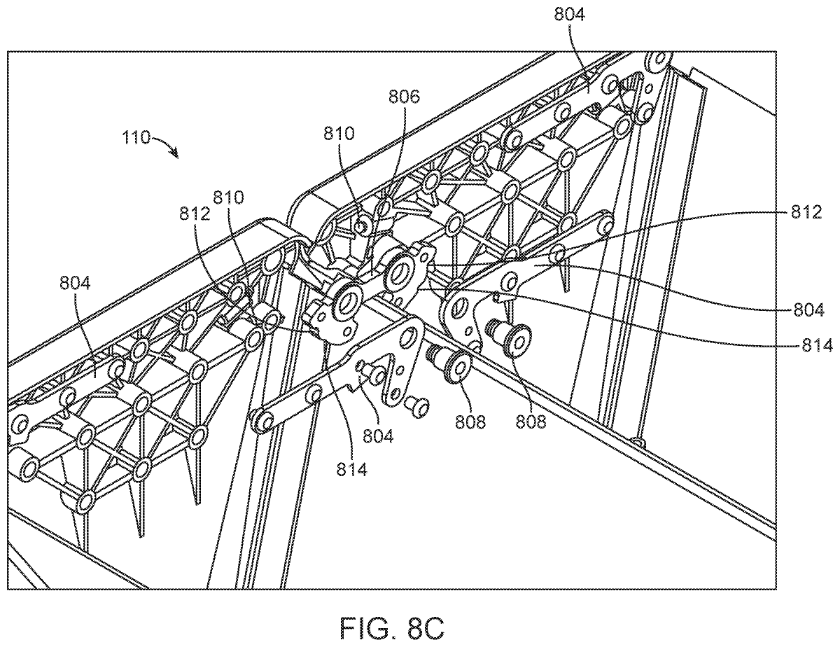

FIGS. 8A-8C illustrate a zoomed-out view, a zoomed in view, and an exploded view respective of an example embodiment of brackets 802 for securing adjacent base elements 110 together. As seen in the exploded view of FIG. 8C, the brackets 802 includes a set of base brackets 804 and a connecting bracket 806. The base brackets 804 are secured to the interior sides of respective adjacent base elements 110. The connecting bracket 806 is coupled to both adjacent base elements 110 and their respective base brackets 804 via a pair of fasteners 808 to secure the adjacent base elements 110 together. The fastener 808 provides a pivot point that enables the base brackets 804 (and base elements 110) to pivot relative to the connecting bracket 806 about the fasteners 808 to enable transitioning between the flat configuration and the stowable configuration. The connecting bracket 806 may include upper detents 812 and lower detents 814 on each side that mate with reciprocal nodes 810 of the respective adjacent base elements 110. In the flat configuration, the nodes 810 mate with the upper detents 812 to stabilize the base elements 110 in the flat configuration. To transition to the stowable configuration, the base elements 110 are pivotable about the fasteners 808 to rotate the base elements 110 such that the nodes 810 align with the lower detents 814, which operate to secure the base elements 110 in the stowable configuration.

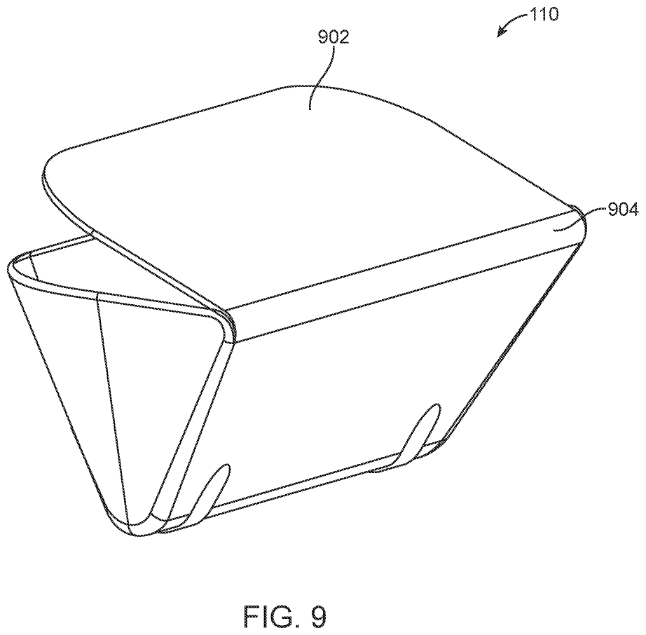

FIG. 9 illustrates an example embodiment of a base element 110 that includes a top plate 902 pivotable about a hinge 904 to enable opening and closing. In an embodiment, the hinge 904 may be included in only a subset of the base elements 110 (e.g., the base element 110 at either the foot end, the head end, or both) for use as a storage compartment as described above. Alternatively, the hinge 904 may be included in all of the base elements 110.

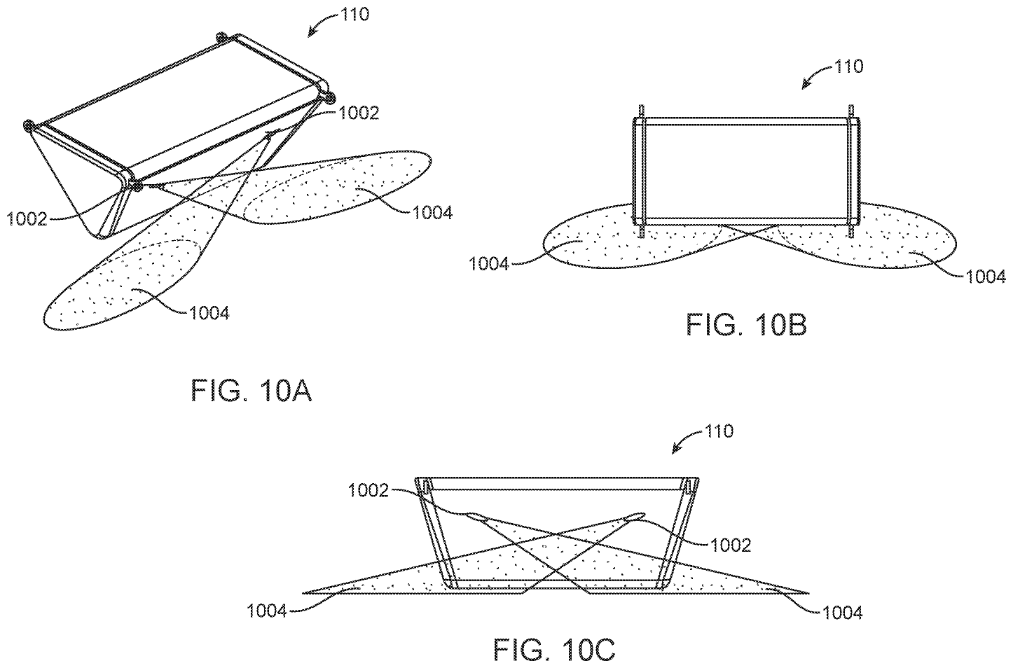

FIGS. 10A-10C illustrate views of an example base element 110 with integrated lighting elements 1002 (e.g., LEDs) for projecting light 1004. In an example embodiment, the lighting elements 1002 may be integrated into a set of angled recesses in the lateral (e.g., trapezoidal) faces of the base elements 110 and may be angled to project the light 1004 onto the floor so that the projections are at least partially visible outside the width of the bed 100. In an embodiment, the angled recesses are positioned near respective upper outer corners of the lateral (trapezoidal) faces of the base elements 110 and each project light to the opposite side of the vibroacoustic therapy bed 100 such that the light cones 1004 cross each other. The lighting elements 1002 may be controlled in a manner synchronized with the vibrations and/or audio tracks. For example, the light pattern may be coordinated with the location, intensity, and/or frequency of vibrations being delivered to the body. In other instances, the light patterns may be controlled entirely independently of the vibration and audio, and may be customized according to a desired experience.

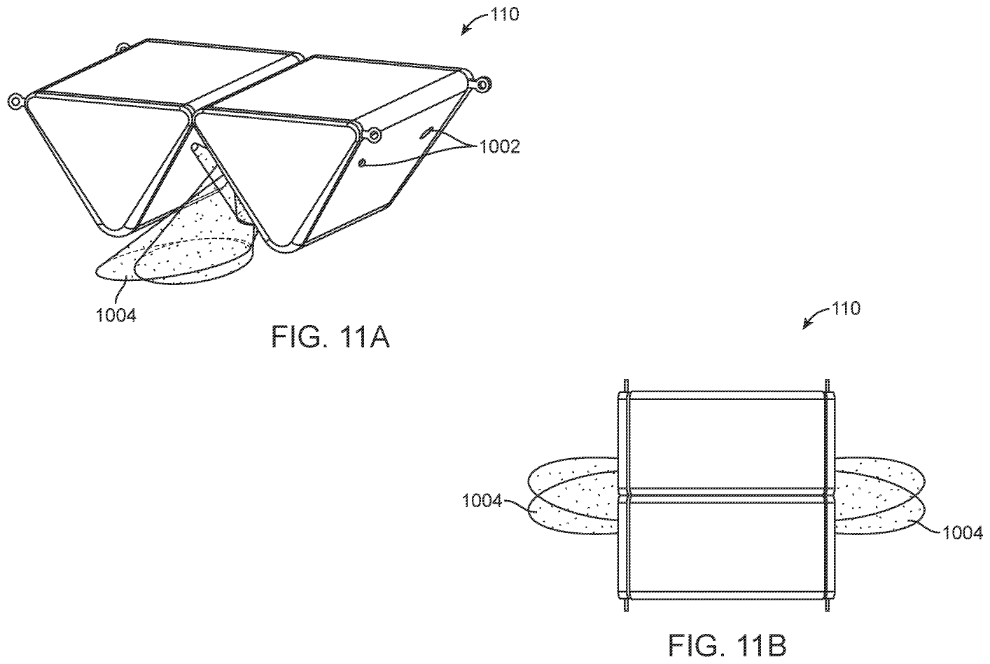

FIGS. 11A-B illustrate views of a pair of example base elements 110 that are coupled together and include the integrated lighting elements 1002 to project a light pattern 1004. In this example, the adjacent base elements 110 have integrated lighting elements 1002 on respective adjacent faces, so that the light cones 1004 from the adjacent base elements 110 overlap each other and are projected on both sides of the vibroacoustic therapy bed 100.

As used herein with respect to various terms describing geometries and form factors, these terms should not be construed to necessarily limit the geometries and form factors to their precise mathematical definitions, but are instead inclusive of variations understood by those skilled in the relevant art as substantially conforming to these geometries and form factors. The described geometries thus may be inclusive of variations from their mathematical definitions due to margins of error, design considerations, or other variations. For example, reference to specific n-sided polygons or prisms may be inclusive of structures having rounded edges or vertices. Moreover, the geometries may be inclusive of structures having various surface ornamentations or textures, or various protruding features, detents, or other structures that cause the resulting geometry to deviate from an exact mathematical definition of the stated geometry. The terms used to describe the geometries and form factors herein should be construed to at least be inclusive of the corresponding structures illustrated in the figures (and those incorporated by reference) and variations understood by those skilled in the art to substantially conform to the stated geometry or form factor.

Upon reading this disclosure, those of skill in the art will appreciate still additional alternative structural and functional designs for the disclosed embodiments from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the disclosed embodiments herein without departing from the scope.

1. A vibroacoustic therapy bed comprising:
a pad; and
a plurality of base elements coupled by hinge connections between adjacent base elements, the base elements including at least one vibrational transducer for generating vibrations responsive to one or more vibration control signals;
wherein the vibroacoustic therapy bed is configurable between:
a flat configuration in which the pad is substantially flat and is supported by the base elements, and
a stowable configuration in which the vibroacoustic therapy bed is pivoted about the hinge connections coupling the adjacent base elements such that the pad forms an outer surface around the base elements.

2. The vibroacoustic therapy bed of claim 1,
wherein in the flat configuration, the vibroacoustic therapy bed comprises a head end and a foot end, and
wherein in the stowable configuration, the head end and the foot end of the vibroacoustic therapy bed come at least substantially in contact.

3. The vibroacoustic therapy bed of claim 1, wherein the pad comprises a plurality of sections with hinge lines between adjacent sections substantially aligned with the hinge connections between the adjacent base elements, and wherein the pad is folded along the hinge lines in the stowable configuration.

4. The vibroacoustic therapy bed of claim 1, wherein the base elements comprise n triangular prisms each having two triangular faces and three trapezoidal faces.

5. The vibroacoustic therapy bed of claim 4,
wherein in the flat configuration, the lower vertex edges of the respective triangular prisms each rest on the ground and upper trapezoidal faces of the triangular prisms opposite the lower edges collectively form a substantially parallel surface supporting the pad, and
wherein in the stowable configuration, the triangular prisms are pivoted into a prism structure having two n-sided polygon exterior faces formed from the triangular faces of the n triangular prisms and the prism structure has n trapezoidal exterior faces corresponding to the upper trapezoidal faces of the base elements.

6. The vibroacoustic therapy bed of claim 4, wherein n=6.

7. The vibroacoustic therapy bed of claim 1, wherein at least one of the base elements comprises a hinged top plate that enables access to an interior compartment.

8. The vibroacoustic therapy bed of claim 1, wherein the plurality of base elements further include:
one or more integrated light emitting devices to project light in response to a lighting control signal.

9. The vibroacoustic therapy bed of claim 8, wherein the one or more integrated light emitting devices are mounted in angled recesses of the base elements to project light onto the ground outside a footprint of the vibroacoustic therapy bed in the flat configuration.

10. The vibroacoustic therapy bed of claim 1, wherein the hinge connections comprise:
a connecting bracket coupling to both of the adjacent base elements;
respective securing brackets coupled to each of the adjacent base elements; and
respective fasteners coupling the respective securing brackets to the connecting bracket, wherein the respective securing brackets are pivotable with respect to the connecting bracket about the respective fasteners.

11. The vibroacoustic therapy bed of claim 1, wherein the hinge connections comprise:
first securing structures for mating with reciprocal securing structures of the adjacent base elements for securing the vibroacoustic therapy bed in the flat configuration; and
second structures for mating with the reciprocal securing structures of the adjacent base elements for securing the vibroacoustic therapy bed in the stowable configuration.

12. The vibroacoustic therapy bed of claim 1, wherein each of the base elements comprises an isolation element for attenuating transfer of vibrational energy from the vibrational transducer to the ground.

13. The vibroacoustic therapy bed of claim 12, wherein the isolation element comprises:
an upper frame including one or more securing structures for securing to a top plate of the base element including the vibrational transducer;
a lower frame for securing between a side face of the base element and the upper frame; and
one or more elastic spacers between the lower frame and the upper frame for absorbing the vibrational energy.

14. The vibroacoustic therapy bed of claim 13, wherein the one or more securing structures of the upper frame comprises:
a clip for securing a spring connector between the upper frame and the top plate of the base element to enable movement of the top plate relative to the upper frame.

15. The vibroacoustic therapy bed of claim 1, wherein each of the base elements comprises:
a load sensor to sense a load applied to the a top plate of the base element under the pad.

16. The vibroacoustic therapy bed of claim 1, wherein each of the base elements comprises:
a proximity sensor to detect removal of a top plate of the base element; and
a control mechanism to disable electronics of the base element responsive to detecting the removal.

17. A base element for a vibroacoustic therapy bed comprising:
one or more vibrational transducers for generating vibrations transferred through a top plate of the base element;
a hinge connector for coupling to an adjacent base element to enable pivoting of the base element and the adjacent base element about a pivot element of the hinge connector; and
an isolation element for attenuating transfer of vibrational energy from the one or more vibrational transducers to the ground.

18. The base element of claim 17, further comprising:
a load sensor to sense a load applied to the the top plate of the base element;
a proximity sensor to detect removal of the top plate of the base element; and
a control mechanism to disable the vibrational transducer responsive to detecting the removal.

19. The vibroacoustic therapy bed of claim 1, wherein the base elements comprises a triangular prism having two triangular faces and three trapezoidal faces.

20. A base element for a vibroacoustic therapy bed comprising:
a triangular prism structure having two substantially triangular faces and three substantially trapezoidal faces, the triangular prism structure including a lower vertex edge for resting on the ground when the vibroacoustic therapy bed is configured in a flat configuration, and a top plate opposite the lower vertex edge for at least partially supporting a pad in the flat configuration; and
one or more vibrational transducers mounted to the top plate for generating vibrations responsive to a vibration control signal.
